(19) United States
(12) Patent Application Publication
(10) Pub. No.: US 2026/0318601 A1
(43) Pub. Date: Oct. 15, 2026

(54) CONTINUOUS HEATING FURNACE COMPRISING SKID RIDERS

(71) Applicant: Hyundai Steel Company, Incheon (KR)

(72) Inventors: Tae Young LEE, Incheon (KR); Chang Hyun Wee, Incheon (KR); Hong Kil Moon, Incheon (KR); Jae Chang Lee, Incheon (KR); Joong Ki Hwang, Incheon (KR); Yong Su Kim, Incheon (KR)

(21) Appl. No.: 19/693,719

(22) Filed: Jun. 1, 2026

Related U.S. Application Data
(63) Continuation of application No. PCT/KR2024/017231, filed on Nov. 5, 2024.

(30) Foreign Application Priority Data
Dec. 1, 2023 (KR) 10-2023-0172564

(51) Int. Cl. F27D 3/02; F27D 3/00

(52) U.S. Cl. CPC F27D 3/024; F27D 2003/0059

(57) ABSTRACT

The present disclosure provides a skid device for a continuous heating furnace, the skid device comprising: a skid beam supporting a material to be heated that is heated inside a heating furnace; and a plurality of skid riders disposed along a longitudinal direction of the skid beam on an upper portion of the skid beam so that the material to be heated is placed thereon and conveyed, wherein a top surface of the skid rider defines a lengthwise dimension (x) as a direction parallel to the longitudinal direction of the skid beam and defines a widthwise dimension (y) as a direction parallel to a width direction of the skid beam, and the widthwise dimension (y) is equal to or greater than the lengthwise dimension (x), and a ratio of the lengthwise dimension to the widthwise dimension is from 0.7 to 1.0.

### CROSS-REFERENCE TO THE RELATED APPLICATIONS

This application is a continuation of International Application No. PCT/KR2024/017231 filed Nov. 5, 2024, which claims the benefit of Korean Patent Application No. 10-2023-0172564, filed Dec. 1, 2023, in the Korean Intellectual Property Office, the entire contents of which applications are incorporated herein by reference.

### FIELD

The present disclosure relates to a continuous heating furnace provided with a skid rider, and more particularly, to a continuous heating furnace provided with a skid rider having a square shape on the top surface so that stress is distributed.

### BACKGROUND

In general, a hot rolling process heats materials such as slab, bloom, and billet, and proceeds in the order of rough rolling, finish rolling, cooling, and straightening to produce rolled steel sheets, bars, wire rods, and the like. The materials are heated to a range of 1100 to 1300° C. inside a heating furnace prior to rolling to reduce the load during rolling and to obtain the mechanical properties required during the cooling process. The heating furnace that heats the material to the rolling temperature is divided into a preheating zone, a heating zone, a soaking zone, and the like, and a certain amount of fuel is continuously supplied to each zone to maintain the required temperature. The material charged into the heating furnace is moved from the charging point to the extraction point, and upon reaching the extraction point, the material is maintained in a heated state at a temperature sufficient for rolling.

The configuration of a conventional heating furnace will be briefly described with reference to (a) of FIG. 1. Inside a general heating furnace, there are a skid beam (2) and a skid rider (8) that support a material to be heated (1) having a rectangular bar shape, and the material to be heated (1) inside the heating furnace comes into direct contact with the skid rider (8). During this process, surface defects occur at the edge portions and the central portion of the bottom surface of the material to be heated.

Conventionally, the operation of the heating furnace was periodically stopped to remove the fused scale formed on the top surface of the skid rider or to replace the skid rider, and after the heating furnace was stopped, workers directly removed the fused scale or proceeded with the replacement of the skid rider. Such interruptions to heating furnace operation became a factor in reducing the operating rate and productivity. In particular, when a surface defect problem occurs on the bottom surface of the material, it is not possible to take immediate action in the high-temperature heating furnace not only to address the quality defect but also to remove the fused scale or replace the skid rider, and action can only be taken after waiting for the temperature to decrease, resulting in significant productivity losses.

Accordingly, attempts were made to suppress surface defects on the material surface by modifying the shape of the skid rider; however, this caused stress concentration in other areas of the material, which in turn became a cause of generating additional surface defects due to indentation.

### SUMMARY

In one aspect, the present disclosure is directed to solving such conventional problems and has an object of reducing surface damage to the bottom edge portions of the material to be heated caused by indentation. However, such problems are merely illustrative, and the scope of the present disclosure is not limited thereby.

According to one aspect of the present disclosure, a skid device for a continuous heating furnace is provided.

In one aspect, a skid device for a heating furnace is provided, the skid device suitably, comprising:
i) a skid beam configured to support a material to be heated inside a heating furnace; and
ii) a plurality of skid riders disposed along a longitudinal direction of the skid beam on an upper portion of the skid beam,
   wherein the skid rider comprises a lengthwise dimension (x) in a direction parallel to the longitudinal direction of the skid beam that is shorter than or equal to a widthwise dimension (y) in a direction parallel to a width direction of the skid beam;
   the widthwise dimension (y) is shorter than or equal to a width length of the skid beam; and
a ratio of the lengthwise dimension (x) to the widthwise dimension (y) is from 0.7 to 1.0.

In aspects, the skid device may further comprise a material to be heated. The material to be heated may be for example or more or more of a metal (e.g. steel composition or alloy composition) in the form of a slab, bloom, and/or billet.

In an aspect, the skid device for the continuous heating furnace comprises: a skid beam supporting a material to be heated that is heated inside the heating furnace; and a plurality of skid riders disposed along the longitudinal direction of the skid beam on an upper portion of the skid beam so that the material to be heated is placed thereon and conveyed, wherein the skid rider is characterized in that a lengthwise dimension (x) in a direction parallel to the longitudinal direction of the skid beam is shorter than or equal to a widthwise dimension (y) in a direction parallel to the width direction of the skid beam, the widthwise dimension (y) is shorter than or equal to the width length of the skid beam, and a ratio of the lengthwise dimension (x) with respect to the widthwise dimension (y) is from 0.7 to 1.0.

According to one embodiment, the ratio of the lengthwise dimension with respect to the widthwise dimension may be from 0.7 to 0.9.

According to one embodiment, an edge portion of the top surface of the skid rider may be subjected to rounding treatment with a curvature of 5R to 10R.

According to one embodiment, the curvature may be from 7.5R to 9R.

According to one embodiment, the material to be heated may be a slab, bloom, or billet that is a rolling material.

According to one embodiment, the maximum stress applied to the skid rider may be characterized as being less than 29 MPa.

In a further aspect, a heating furnace is provided that comprises a skid device as disclosed herein. Suitably, the heating furnace is a continuous heating furnace.

In a yet further aspect, methods for heating a material as disclosed herein are provided, including methods of heating a material in a heating furnace, suitably comprising: a) providing a heating furnace comprising: i) a skid beam configured to support a material to be heated inside a heating furnace; and ii) a plurality of skid riders disposed along a longitudinal direction of the skid beam on an upper portion of the skid beam, wherein the skid rider comprises a lengthwise dimension (x) in a direction parallel to the longitudinal direction of the skid beam that is shorter than or equal to a widthwise dimension (y) in a direction parallel to a width direction of the skid beam, the widthwise dimension (y) is shorter than or equal to a width length of the skid beam, and a ratio of the lengthwise dimension (x) to the widthwise dimension (y) is from 0.7 to 1.0; and b) heating a material on the skid beam within the furnace. Suitably, the heating furnace is a continuous heating furnace.

According to the embodiments of the present disclosure as described above, the stress concentration phenomenon occurring at the edge portions of the material is mitigated, and quality defects can be reduced due to the reduction of surface damage.

Of course, the scope of the present disclosure is not limited by these effects.

### BRIEF DESCRIPTION OF THE DRAWINGS

FIG. 1 is a schematic diagram showing a skid device for a continuous heating furnace according to an embodiment of the present disclosure.

FIG. 2 is a perspective view showing the shapes of a skid rider according to the prior art and an embodiment of the present disclosure.

FIG. 3 is a schematic diagram showing a surface defect occurrence pattern of a material to be heated when a conventional skid rider is applied.

FIGS. 4 to 6 are graphs showing the analysis results of maximum stress (MPa) according to changes in the aspect ratio of the skid rider in accordance with an embodiment of the present disclosure, and simulation results thereof.

FIG. 7 is a perspective view exemplarily showing a state in which the curvature (R) of the top surface edge portion of the skid rider according to an embodiment of the present disclosure has been changed.

FIGS. 8 to 10C are graphs showing the analysis results of maximum stress (MPa) according to changes in the curvature (R) of the top surface edge portion of the skid rider in accordance with an embodiment of the present disclosure, and simulation results thereof.

### DETAILED DESCRIPTION

Hereinafter, various embodiments of the present disclosure will be described in detail with reference to the accompanying drawings. The embodiments of the present disclosure are provided to more completely explain the present disclosure to those skilled in the art, and the following embodiments may be modified in various different forms, and the scope of the present disclosure is not limited to the following embodiments. Rather, these embodiments are provided to make the present disclosure more faithful and complete, and to fully convey the spirit of the present disclosure to those skilled in the art. In addition, the thickness or size of each layer in the drawings is exaggerated for convenience and clarity of description.

Hereinafter, a skid device for a continuous heating furnace according to an embodiment of the present disclosure will be described.

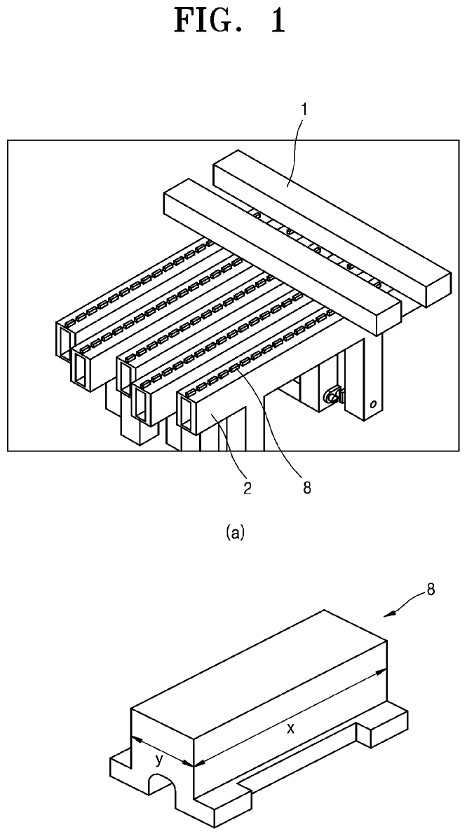

FIG. 1 is a schematic diagram showing a skid device for a continuous heating furnace according to an embodiment of the present disclosure.

In the hot rolling process, a walking beam type heating furnace is used for heating steel materials. This heating furnace is equipped with a plurality of rows of skid beams (2) for supporting and conveying a material to be heated (1) such as a slab, bloom, or billet, which is a rolling material.

The skid beam (2) is composed of a moving beam and a fixed beam, and conveys the material to be heated (1) by periodically repeating the lifting and horizontal reciprocating motions of the moving beam, thereby alternately transferring the material to be heated (1) between the moving beam and the fixed beam.

On the upper portion of the skid beam (2), a plurality of skid riders (8) are arranged at regular intervals in the longitudinal direction. As shown in (b) of FIG. 1, the skid rider (8) is a block having the shape of a rectangular column, and its top surface is in direct contact with the material to be heated (1). As such, the skid rider (8) is a member that contacts the material to be heated (1), and there are problems such as deformation and surface defects occurring due to the load of the material to be heated (1).

The present disclosure provides a skid device having a shape capable of effectively distributing the stress applied to the skid rider (8) in order to solve the above problems. Specifically, a stress reduction effect is provided through improvement of the structure of the top surface, which is the interface at which the skid rider (8) contacts the material to be heated (1).

The skid rider (8) of the present disclosure controls the stress applied to the skid rider (8) by optimizing the ratio of the lengthwise dimension (x) of the top surface to the widthwise dimension (y) of the top surface. Here, the length of the top surface in the direction parallel to the longitudinal direction of the skid beam (2), i.e., the conveying direction of the material to be heated (1), is defined as the lengthwise dimension (x). In addition, the length of the top surface in the direction parallel to the width direction of the skid beam (2) is defined as the widthwise dimension (y).

In an embodiment of the present disclosure, the lengthwise dimension (x) is shorter than or equal to the widthwise dimension (y), and the widthwise dimension (y) is shorter than or equal to the width length of the skid beam (2).

If the widthwise dimension (y) is longer than the width length of the skid beam (2), there is a concern that at least a portion of the skid rider (8) may not be supported by the skid beam (2), and thus sufficient strength to withstand the load of the material to be heated (1) may not be secured. Therefore, it is preferable that the widthwise dimension (y) is formed to be shorter than or at most equal to the width length of the skid beam (2).

The reason for limiting the widthwise dimension (y) to within the width length of the skid beam (2) while making the lengthwise dimension (x) equal to or shorter than the widthwise dimension (y) is to increase the number of skid riders (8) supporting the material to be heated (1) compared to a conventional skid rider of the same area, thereby distributing the load of the material to be heated (1) across multiple skid riders (8).

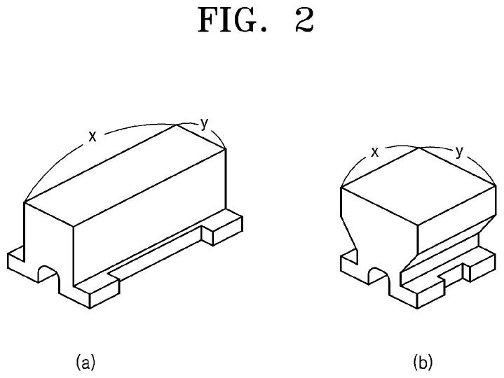

Hereinafter, a detailed description will be given with reference to FIG. 2.

FIG. 2 is a perspective view exemplarily showing the shapes of a conventional skid rider and a skid rider according to an embodiment of the present disclosure.

Referring to FIG. 2, the conventional skid rider (a) is arranged elongated in the direction in which the material to be heated advances, and is characterized in that it has a rectangular shape in which the lengthwise dimension (x) of the top surface is longer than the widthwise dimension (y). On the other hand, the skid rider (b) of the present disclosure has the same height and material as the conventional skid rider (a), but is characterized in that the top surface is provided in a shape close to a square shape, thereby broadly expanding the area of contact with the material to be heated in the longitudinal direction of the material to be heated.

Specifically, the skid rider according to an embodiment of the present disclosure may have the same top surface area as the conventional one, but with a changed ratio of lateral to longitudinal dimensions. In this case, it is preferable that the skid rider is arranged along the longitudinal center line of the skid beam.

In FIG. 2, in the case of (b) according to an embodiment of the present disclosure, the lengthwise dimension (x) and the widthwise dimension (y) are substantially equal. Preferably, the ratio of the lengthwise dimension (x) to the widthwise dimension (y) (hereinafter, aspect ratio) is from 0.7 to 1.0, and more preferably from 0.7 to 0.9. On the other hand, the conventional skid rider (a) has a large deviation between the lengthwise dimension (x) and the widthwise dimension (y), and for example, the aspect ratio may be 3 or more.

According to the embodiment of the present disclosure, the number of skid riders (8) supporting the material to be heated (1) in a given area of the skid beam increases, so that the load of the material to be heated (1) can be distributed across multiple skid riders (8).

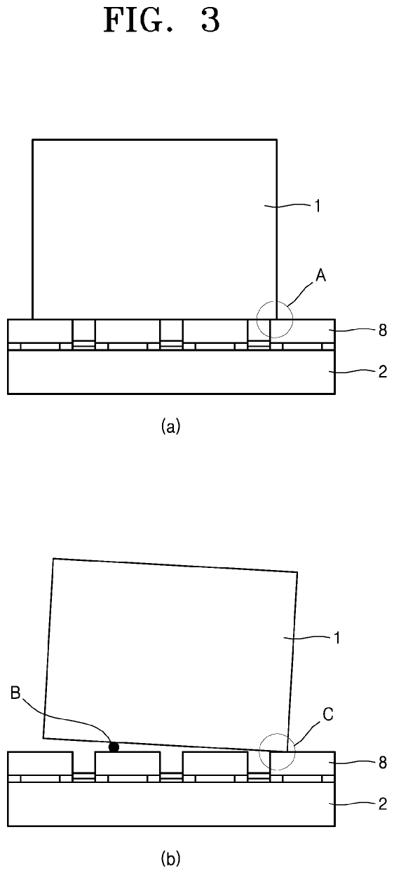

FIG. 3 is a schematic diagram showing the pattern of surface defects occurring on the material to be heated when a conventional skid rider having a rectangular shape as shown in (a) of FIG. 2 is applied.

Referring to (a) of FIG. 3, in the process in which the skid rider (8) supports the bottom surface of the material to be heated (1), local stress is concentrated in region A where the contact area between the skid rider (8) and the material to be heated (1) is narrow, and there is a high probability that surface defects will occur on the bottom surface of the material to be heated (1).

In addition, during the heating operation of the material to be heated inside the heating furnace, a scale layer, which is a metal oxide generated on the surface of the material to be heated, adheres to the skid rider (8) supporting the material to be heated (1), and at this time, the scale layer is peeled off from the material to be heated (1) and remains on the skid rider (8).

(b) of FIG. 3 shows the tilting phenomenon of the material to be heated (1) caused by foreign matter (B) including oxidation scale deposited on the upper portion of the skid rider (8) and shows that stress concentration due to line contact occurs in region C, which is the upper region of another skid rider.

As described above, in the case of the conventional skid rider, surface defects occur in the material to be heated inside the heating furnace due to stress concentration in the skid rider and indentation at the edge portions.

Accordingly, in the embodiment of the present disclosure, the top surface of the skid rider was changed to a square shape to mitigate the stress concentration on the bottom surface of the material to be heated and to improve the surface defect occurrence phenomenon. Since the skid rider is an expensive component manufactured from a heat-resistant casting material, it was intended to change the shape of the skid rider under the condition of a constant volume, and the optimal shape necessary for the mitigation of concentrated stress was derived by varying the aspect ratio of the lateral and longitudinal dimensions of the skid rider.

As seen in (b) of FIG. 2, the skid rider according to an embodiment of the present disclosure has a square shape on the top surface, and as a result, the probability of surface defect occurrence can be reduced. As the top surface of the skid rider changes to a square shape, the total length of the edge portions of the top surface decreases, and the area susceptible to indentation of the material to be heated during the heating operation can be minimized.

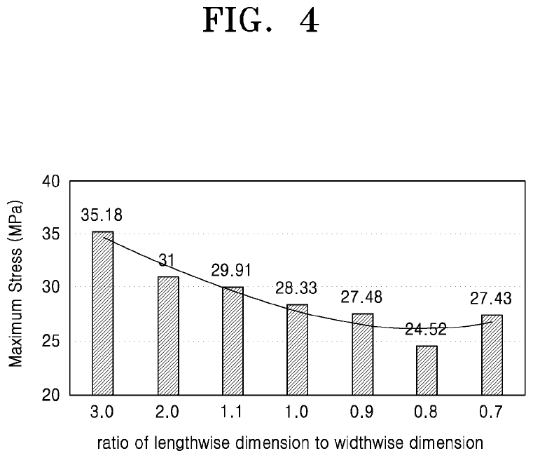

FIG. 4 is a graph showing the analysis results of maximum stress (MPa) according to changes in the aspect ratio of the skid rider according to an embodiment of the present disclosure.

Referring to FIG. 4, it can be seen that the maximum stress (MPa) gradually decreases as the aspect ratio of the skid rider decreases from 3.0 to 1.0. This tendency is maintained until the aspect ratio reaches 0.8, and it can be seen that the maximum stress slightly increases when the aspect ratio reaches 0.7. Therefore, it can be confirmed that the most ideal maximum stress (MPa) value is derived when the aspect ratio is around 0.8.

Specifically, when the aspect ratio of the skid rider was in the range of 0.7 to 1.0, the maximum stress applied to the skid rider was found to be less than 29 MPa, and more preferably, when the aspect ratio of the skid rider was in the range of 0.7 to 0.9, the maximum stress was confirmed to be less than 28 MPa.

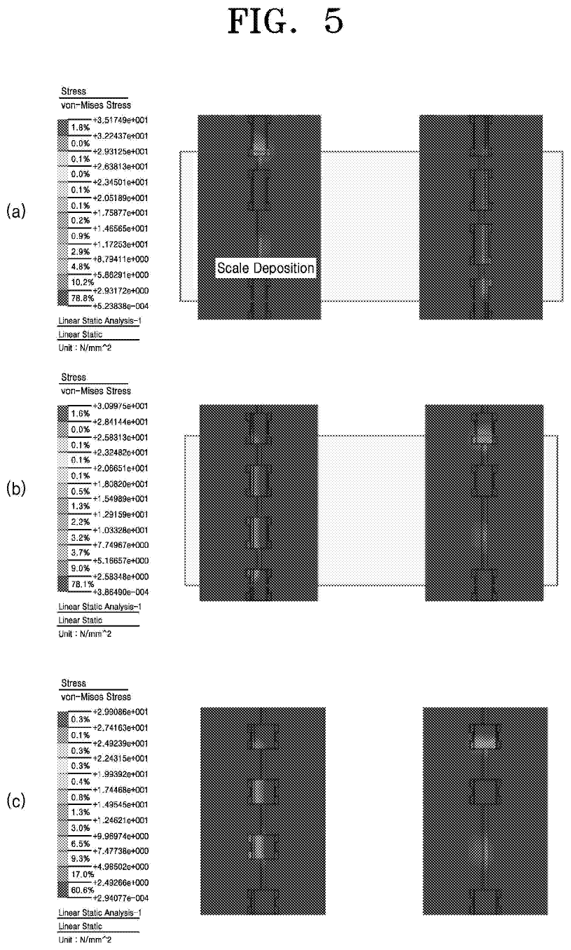

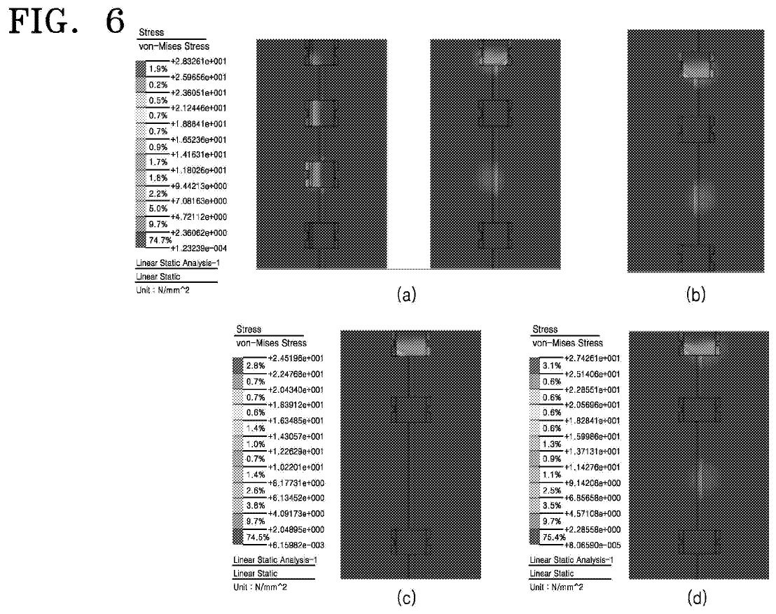

FIGS. 5 to 6 are simulation results from which the results shown in FIG. 4 were derived.

In FIG. 5, the aspect ratios are (a) 3.0, (b) 2.0, and (c) 1.1, respectively, and in FIG. 6, the aspect ratios are (a) 1.0, (b) 0.9, (c) 0.8, and (d) 0.7, respectively.

For example, different aspect ratios were set by varying the widthwise dimension (y) while fixing the lengthwise dimension (x).

In FIGS. 5 (a) to (b), it was confirmed that scale is deposited due to stress concentration, and as the stress is concentrated, there is a high probability of forming additional surface defects. Compared to FIG. 5, it was confirmed that the stress concentration phenomenon was relatively mitigated in the case of FIG. 6.

According to another aspect of the present disclosure, by applying rounding treatment to the edge portions of the top surface of the skid rider, an effect of reducing the average stress can be expected.

In the present disclosure, the skid rider may be curved with various curvatures (R) according to a desired shape; however, if the curvature is too small, stress may be concentrated in the central portion of the skid rider, causing deformation such as twisting, and conversely, if the curvature is too large, it is difficult to control the curvature.

Therefore, the edge portions of the top surface of the skid rider may have a structure forming a curved surface within a curvature (R) range of 5R to 10R. More preferably, a curvature (R) of 7.5R to 9R may be provided. A larger curvature means a greater degree of bending, and a smaller curvature means a lesser degree of bending. In the present disclosure, the unit of curvature (R) may be millimeters or centimeters.

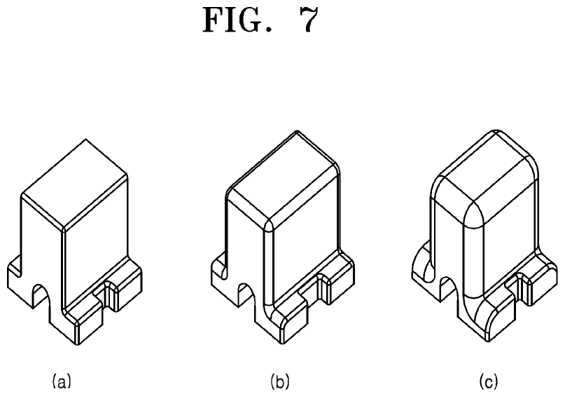

FIG. 7 is a perspective view exemplarily showing the appearance of the edge portions of the top surface of the skid rider with changed curvature (R) according to an embodiment of the present disclosure.

Referring to FIG. 7, the curvature of the edge portions increases in the order of (a) R2, (b) R5, and (c) R10.

The radius of the circle at all points on the curved surface of the edge portions may be slightly different, but this falls within the error range of the manufacturing process, and may be regarded as having substantially the same curvature. In detail, the curvature (R) may be defined as the average of the curvatures on the curved surface.

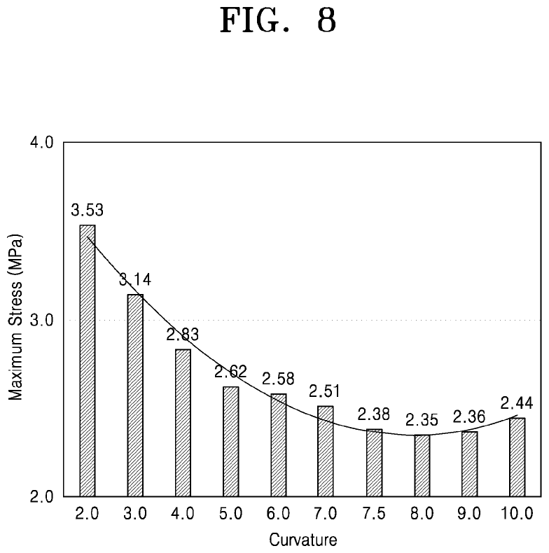

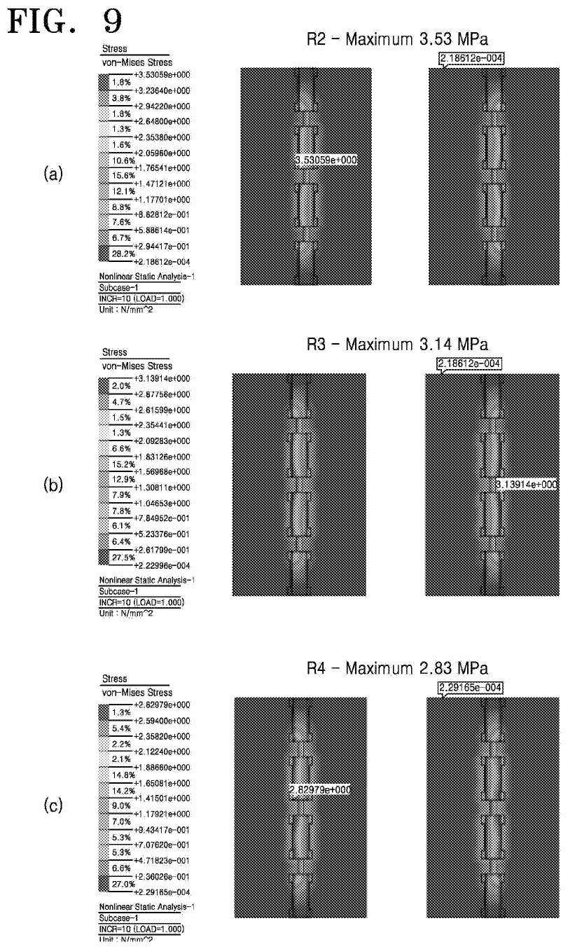

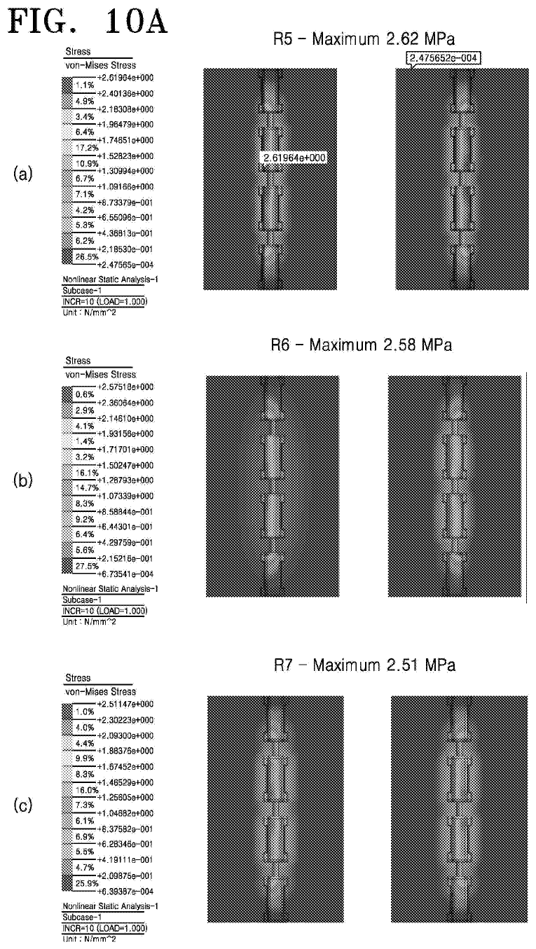

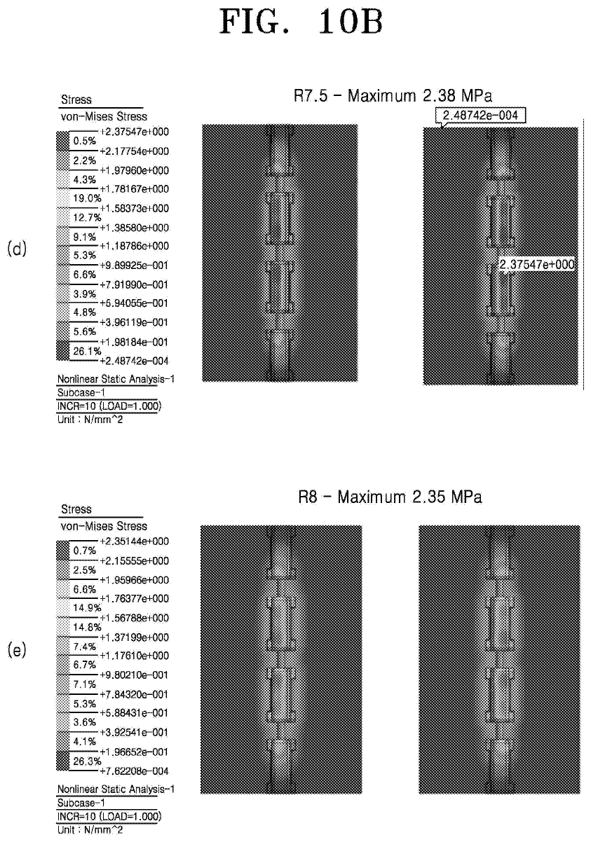

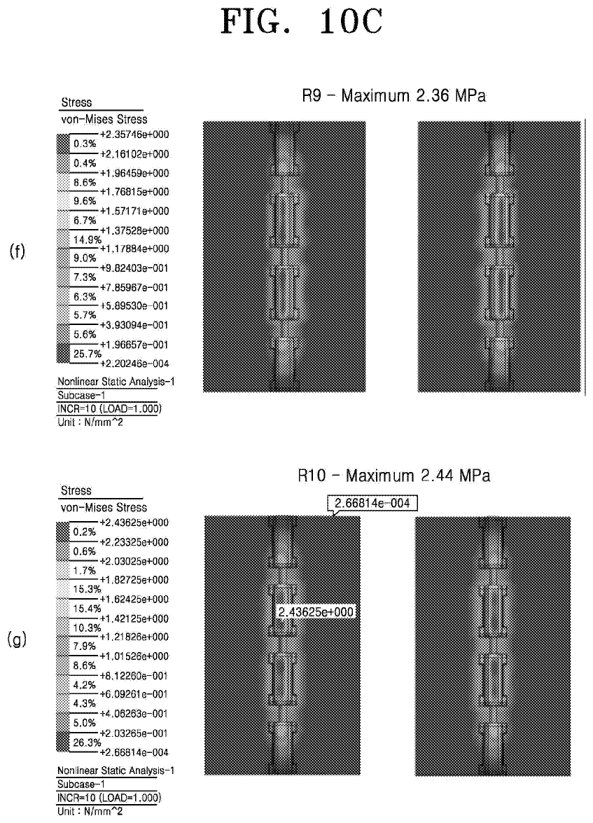

FIGS. 8 to 10C are graphs showing the analysis results of maximum stress (MPa) according to changes in the curvature (R) of the edge portions of the top surface of the skid rider according to an embodiment of the present disclosure, and simulation results thereof.

Referring to FIGS. 8 to 10C, it can be seen that the maximum stress (MPa) gradually decreases as the curvature (R) of the skid rider increases from 2.0 to 8.0. That is, the maximum stress reaches its minimum value at a curvature of 8.0, and it can be seen that the maximum stress slightly increases when the curvature exceeds 8.0. Therefore, when considering the maximum stress, a curvature (R) range of 5R to 10R, or 7.5R to 9R, is preferable.

### EXPERIMENTAL EXAMPLE

Hereinafter, preferred experimental examples are presented to aid in understanding the present disclosure. However, the following experiments are only intended to aid in understanding the present disclosure, and the present disclosure is not limited by the following experimental examples.

A conventional skid rider having a rectangular shape with an aspect ratio of 3 and a skid rider according to an embodiment of the present disclosure having a square shape with an aspect ratio of 0.9 were applied, and after heating blooms, 5 blooms each were randomly sampled and the number of surface defects at the edge portions was measured.

The result obtained by dividing the number of edge portion surface defects by the total number of surface defects was derived as the surface defect occurrence rate, and the results are shown in Table 1. In the conventional case, the average edge portion surface defect occurrence rate was 0.23, and in the present disclosure, it was 0.08, confirming that the surface defect occurrence amount of the inventive material was reduced by 15% compared to the conventional material.

TABLE 1

| Bloom No. | Conventional | Present Disclosure |
|---|---|---|
| 1 | 0.25 | 0.1 |
| 2 | 0.20 | 0 |
| 3 | 0.35 | 0.2 |
| 4 | 0.20 | 0.1 |
| 5 | 0.15 | 0 |
| Average | 0.23 | 0.08 |

According to the embodiment of the present disclosure as described above, the stress concentration phenomenon occurring at the edge portions of the material is mitigated, and there is an effect of reducing quality defects due to the reduction of surface defects.

Although the present disclosure has been described with reference to the embodiments shown in the drawings, these are merely illustrative, and those skilled in the art will understand that various modifications and equivalent other embodiments are possible therefrom. Therefore, the true technical protection scope of the present disclosure should be determined by the technical spirit of the appended claims.

1. A skid device for a heating furnace, comprising:
a skid beam configured to support a material to be heated inside a heating furnace; and
a plurality of skid riders disposed along a longitudinal direction of the skid beam on an upper portion of the skid beam,
wherein the skid rider comprises a lengthwise dimension (x) in a direction parallel to the longitudinal direction of the skid beam that is shorter than or equal to a widthwise dimension (y) in a direction parallel to a width direction of the skid beam,
the widthwise dimension (y) is shorter than or equal to a width length of the skid beam, and
a ratio of the lengthwise dimension (x) to the widthwise dimension (y) is from 0.7 to 1.0.

2. The skid device of claim 1, wherein the ratio of the lengthwise dimension (x) to the widthwise dimension (y) is from 0.7 to 0.9.

3. The skid device of claim 1, wherein an edge portion of a top surface of the skid rider is subjected to a rounding treatment with a curvature of 5R to 10R.

4. The skid device of claim 3, wherein the curvature is from 7.5R to 9R.

5. The skid device of claim 1, wherein the material to be heated is a slab, bloom, or billet that is a rolling material.

6. The skid device of claim 1, wherein a maximum stress applied to the skid rider is less than 29 MPa.

7. The skid device of claim 1 further comprising a material to be heated.

8. The skid device of claim 7 wherein the material to be heated is a slab, bloom, and/or billet.

9. A heating furnace comprising a skid device of claim 1.
